(19) United States
(12) Patent Application Publication
(10) Pub. No.: US 2008/0128982 A1
(43) Pub. Date: Jun. 5, 2008

(54) Gripper System for a Cylinder of a Sheet-Fed Printing Press Which Guides Sheets

(76) Inventors: Jorg Eidam, Noerdlingen (DE); Georg Herzan, Oberursel/Taunus (DE)

Correspondence Address: COHEN, PONTANI, LIEBERMAN & PAVANE, 551 FIFTH AVENUE, SUITE 1210, NEW YORK, NY, 10176, US

(21) Appl. No.: 11/791,597

(22) PCT Filed: Nov. 16, 2005
(86) PCT No.: PCT/EP2005/012268

§ 371 Date: May 24, 2007

(30) Foreign Application Priority Data
Nov. 26, 2004 (DE) 20 2004 018 313.7

(51) Int. Cl. B41F 21/04

(52) U.S. Cl. 271/249

(57) ABSTRACT

The invention relates to a gripper system (100) for a cylinder (3) of a sheet-fed printing press (1) which guides sheets and which is used to detect printed sheets. Said system comprises a gripping shaft (9) and grippers (8) which are arranged on the gripper shaft (9) and which, during a synchronised normal operation, can be introduced into a cylinder channel of a cylinder (3) which guides the sheet, by means of a pivoting movement of gripper shaft (9), such that the gripper (8) is arranged completely in the cylinder contour after pivoting. According to the invention, the gripper system (100) can be displaced in a radial manner during a cylinder phase displacement such that the grippers (8) of the gripper system (100) enter into a recess and strike an elastically mounted gripper strike bar (10) which enables the gripper (8) to be struck during the radial displacement of the gripper system (100).

The invention concerns a gripper system for a sheet-guiding cylinder of a sheet-fed press in accordance with the introductory clause of Claim 1.

DE 30 49 067 C2 describes a gripper mechanism on the sheet-guiding cylinder of a sheet-fed rotogravure press for gripping the sheet stock. The gripper mechanism is swiveled about a pivot point located on the circumference of the cylinder by a swiveling mechanism and in this way can be swiveled into the cylinder groove of the sheet-guiding cylinder in such a way that, after they have been swiveled in, the grippers are located entirely within the contour of the sheet-guiding cylinder. A cam follower is provided on the gripper shaft of the gripper mechanism beyond each end face of the cylinder. The cam follower rolls on a cam plate fixed to the machine frame and forces the gripper mechanism against the force of a spring into a retracted position, depending on the position of the cylinder. The retraction movement is determined by the shape of the cam plate and by guides formed in the cylinder groove.

If, in the case of the gripping mechanism described above, the cylinders are individually driven, for example, by electric drives, there is the danger of a collision between the cylinders in printing couples, if the correct coordination with respect to the rotational position between the working elements is lost, and then the grippers of the sheet-guiding cylinder can damage, for example, a blanket of a blanket cylinder, or the blanket cylinder can displace or damage the grippers. It is also necessary to consider the possibility of relative shifts, which occur in printing couples between plate cylinders and blanket cylinders or between impression cylinders and transfer cylinders and are likewise possible between form cylinders and impression cylinders in a coating module. A phase displacement between the working elements can occur, for example, in the event of a power failure.

The objective of the invention is to make available a gripper system for a sheet-guiding cylinder of a sheet-fed press that virtually prevents damage in the event of loss of synchronization.

The invention achieves this objective by making available a gripper system for a sheet-guiding cylinder of a sheet-fed press with the features of Claim 1.

Advantageous embodiments and refinements of the invention are specified in the dependent claims.

In accordance with the invention, a gripper system for a sheet-guiding cylinder of a sheet-fed press is designed with the capability of moving radially during a cylinder phase displacement, so that grippers of the gripper system retract into a retraction recess and strike a spring-mounted gripper strike bar, which allows retraction of the grippers during the radial displacement of the gripper system. Since the spring-mounted gripper strike bar retracts, a gripper shaft with the grippers can be pressed in an advantageous way below the periphery of the sheet-guiding cylinder and can thus be moved out of the collision zone. As a result, in the event of loss of synchronization between the cylinders, damage is advantageously prevented in a printing press with separately driven cylinders. The coordination between the working elements can be lost, for example, during a power failure.

In a refinement of the gripper system of the invention, the spring mounting of the gripper strike bar is realized, for example, by guide pins and compression springs.

In another refinement, the gripper system of the invention includes a cam which is laterally mounted on a blanket cylinder and whose radius extends into the sheet-guiding cylinder, such that the cam is recessed in the area of the grippers. As a result of the recess, proper use of the grippers is made possible in synchronized normal operation, since, in the area of the recess, the grippers can extend beyond the contour of the sheet-guiding cylinder to grip the sheets of printing paper. If there is a phase displacement between the cylinders, then the cam contour causes the gripper system to be radially displaced and the grippers to be moved out of the collision zone.

In a further refinement of the gripper system of the invention, the gripper strike bar has an opposing cam, which extends beyond the radius of the sheet-guiding cylinder in the area of the grippers and cooperates with the cam of the cooperating cylinder, for example, a blanket cylinder, in such a way that the gripper strike bar retracts during a phase displacement.

In a further refinement of the gripper system of the invention, the gripper shaft has a cam follower lever, which, during synchronized normal operation, retracts into a recess in the cam of the cooperating cylinder, for example, a blanket cylinder, and which, during a phase displacement between the blanket cylinder and the sheet-guiding cylinder, causes, by means of the cam, the gripper strike bar to retract and the grippers subsequently to retract into the retraction recess.

The components of the gripper system of the invention that have been described are designed and installed in such a way that synchronized normal operation of the printing press is possible, and that, when loss of synchronization occurs, the interaction of the individual components causes the grippers to retract, thereby preventing collisions and damage.

The cylinders of the gripper system are preferably equipped with electric drives that allow them to be driven separately.

An advantageous embodiment of the invention is illustrated in the drawings and is described below.

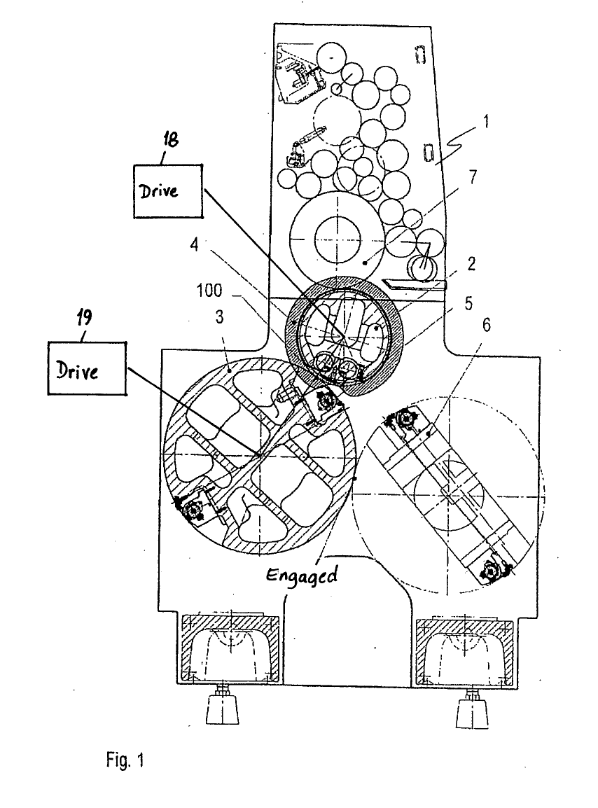

FIG. 1 shows a schematic view of a printing couple of a sheet-fed rotary press to illustrate the components that are essential parts of the invention.

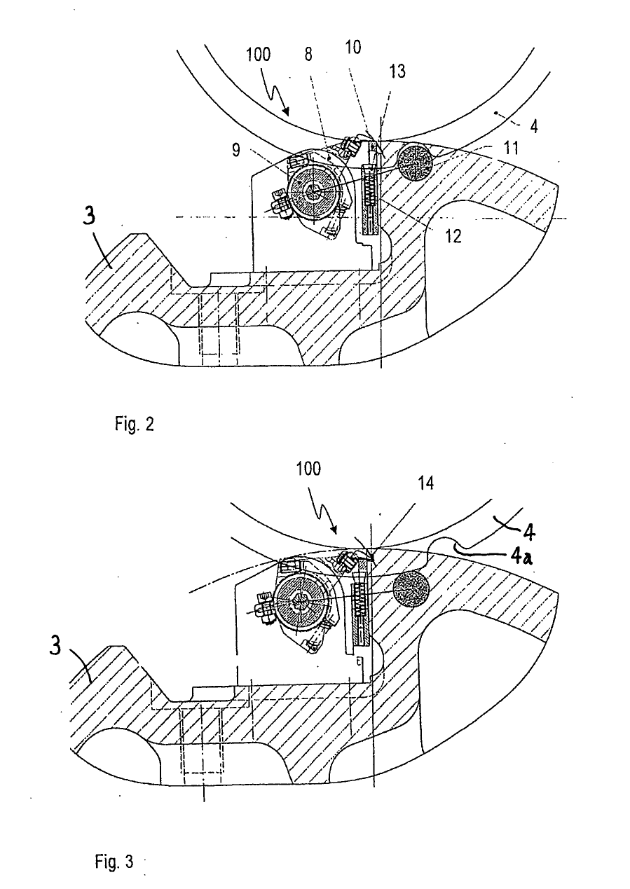

FIG. 2 is a schematic detail drawing of an impression cylinder from FIG. 1 during synchronized normal operation.

FIG. 3 is a schematic detail drawing of the impression cylinder from FIG. 1 during a cylinder phase displacement.

As FIG. 1 shows, a sheet-fed press 1 comprises, as components that are essential parts of the invention, a blanket cylinder 2 with a cam 4 and an impression cylinder 3 with a gripper system 100, which comprises a gripper strike bar 10, a gripper shaft 9, and grippers 8 mounted on the gripper shaft 9. As FIG. 1 also shows, the blanket cylinder 2 cooperates with a plate cylinder 7, and the impression cylinder 3 meshes with a transferter 6. The radius of the cam 4, which is laterally mounted on the blanket cylinder, extends into the impression cylinder 3, such that the cam 4 is recessed in the area of the grippers 8, thereby allowing synchronized normal operation of the printing press.

As the schematic detail drawings in FIGS. 2 and 3 show, a gripper system 100 for the impression cylinder 3 for gripping sheets of printing paper comprises the gripper shaft 9, grippers 8 mounted on the gripper shaft 9, a spring-mounted gripper strike bar 10, and a cam follower lever 11, which interacts with the cam 4 of the blanket cylinder 2 and with the gripper shaft 9 to effect radial movement of the grippers 8. As a result of a recess in the cam 4, proper use of the grippers 8 is made possible in synchronized normal operation, since the grippers 8 can extend beyond the contour of the impression cylinder 3 to grip the sheets of printing paper when the cam follower lever 11 engages the recess of the cam 4 in this area. This state of the gripper system 100 is shown in FIG. 2. In addition, during synchronized normal operation, a swiveling movement of the gripper shaft 9 can swivel the grippers 8 into a cylinder groove of the impression cylinder 3 in such a way that, after they have been swiveled in, the grippers 8 are located entirely within the contour of the impression cylinder 3.

In the case of a cylinder phase displacement, the gripper system 100 is shifted radially, so that the grippers 8 of the gripper system 100 retract into a retraction recess 14 and strike a spring-mounted gripper strike bar 10, which allows the grippers 8 to retract during the radial displacement of the gripper system 100. As FIG. 3 shows, during a phase displacement between the blanket cylinder 2 and the impression cylinder 3, which is caused, for example, by a power failure, the cam follower lever 11 does not lie in the recess in the cam 4 but rather on the cam 4. This causes the spring-mounted gripper strike bar 10 to retract, and the cam follower lever 11 causes, via the gripper shaft 9, a subsequent retraction of the grippers 8 into the retraction recess 14. The spring mounting of the gripper strike bar 10 is realized, for example, by guide pins 13 and compression springs 12.

### LIST OF REFERENCE NUMBERS

1 printing press

2 blanket cylinder

3 impression cylinder

4 cam

6 transferter

7 plate cylinder

8 gripper

9 gripper shaft

10 gripper strike bar

11 cam follower lever

12 compression spring

13 guide pin

14 retraction recess

100 gripper system

1.-6. (canceled)

7. A gripper system in a sheet-guiding cylinder of a sheet-fed press for gripping sheet stock, comprising:
a gripper shaft rotatably mounted in the sheet-guiding cylinder;
grippers mounted on the gripper shaft, the grippers being swivelable into a cylinder groove defined in the sheet-guiding cylinder by a swiveling movement of the gripper shaft during normal operation such that the grippers are located within an outer contour of the sheet-guiding cylinder, at least a portion of the gripper system configured to move radially during a phase displacement of the sheet guiding cylinder relative to a cooperating cylinder in the sheet-fed press; and
a gripper strike bar movably arranged in the sheet-guiding cylinder using a spring mounting, the spring mounted gripper strike bar configured to move to a position allowing retraction of the grippers into a retraction recess when the at least a portion of the gripper system is radially displaced.

8. The gripper system of claim 7, wherein the spring mounting comprises a guide pin and a spring.

9. The gripper system of claim 1, further comprising a cam mounted on the cooperating cylinder and having a radius extending into the sheet-guiding cylinder, said cam having a recess in an area of said grippers during synchronized normal operation of the sheet-guiding cylinder and the cooperating cylinder.

10. The gripper system of claim 9, wherein the strike bar includes an opposing cam which causes the strike bar to retract during a phase displacement between the sheet-guiding cylinder and the cooperating cylinder.

11. The gripper system of claim 9, further comprising a cam follower lever connected to said gripper shaft, said cam follower enters said recess of said cam during synchronized normal operation and interacts with an outer radius of the cam during phase displacement so that the strike bar retracts during phase displacement, thereby allowing the grippers to retract into the retraction recess.

12. The gripper system of claim 9, wherein the sheet-guiding cylinder and the cooperating cylinder are driven by separate drives.

13. The gripper system of claim 9, wherein the cooperating cylinder is a blanket cylinder.
